(19) United States
(12) Patent Application Publication
(10) Pub. No.: US 2010/0320431 A1
(43) Pub. Date: Dec. 23, 2010

(54) Jack

(75) Inventors: Carl William Upton, Corowa (AU); Paul William Upton, Corowa (AU)

Correspondence Address: STITES & HARBISON PLLC, 1199 NORTH FAIRFAX STREET, SUITE 900, ALEXANDRIA, VA, 22314, US

(73) Assignee: Upton Engineering Pty Ltd

(21) Appl. No.: 12/792,169

(22) Filed: Jun. 2, 2010

Related U.S. Application Data
(60) Provisional application No. 61/186,157, filed on Jun. 11, 2009.

(30) Foreign Application Priority Data
Jun. 2, 2009 (AU) 2009902518

(51) Int. Cl. B60S 9/04; B66F 3/22; B66F 3/44

(52) U.S. Cl. 254/418; 254/122

(57) ABSTRACT

A jack for raising a load, the jack being adapted to be fixed to the load; the jack comprising driving means coupled to a linkage which can be driven from an upper position to a lower position in order to raise the load, the driving means comprising a rotating crank for driving the linkage whereby in one revolution the crank drives the linkage from the upper to the lower and back to the upper position, the linkage being a parallelogram linkage comprising a base plate pivotally attached to support arms pivotally secured to the load whereby in the lower position the support arms of the linkage are substantially perpendicular to the base plate to raise the load.

### FIELD OF THE INVENTION

The present invention relates to a jack for raising a load.

### BACKGROUND

Centre pivot irrigators have been used extensively by farmers in many parts of the world since the late 1950s. Such irrigators are made up of a central hub which is positioned in the centre of the field to be irrigated. An irrigation pipeline extends from this hub across the field to be irrigated.

At intervals along the pipeline a series of nozzles distribute water onto the crop. The pipeline is supported above the crop on a series of support towers, the pipeline is typically between 50 m and 500 m long and supported on more than ten support towers.

Each support tower rests on wheels allowing the entire pipeline to rotate a full 360° around the hub so as to irrigate a large circular area. The wheels are typically powered by a hydraulic or electric motor located at each wheel.

In some cases pivot irrigators are permanently installed in a single field. However, towable units are also common which allow a single irrigator to be towed between various fields. Towable irrigators are typically towed along their length, in the direction of the pipeline.

In order to pivot around the field, the wheels on each tower must run perpendicular to the pipeline in operation, while during towing the wheels must rotate 90° to be parallel with the pipeline.

Given the weight of the towers and pipeline, considerable force is required to lift each tower before the wheels can be rotated into a towing position (parallel to the pipeline). Various jacks have been produced to lift the towers to facilitate rotation of the wheels. Both manual and hydraulic jacks are common.

Known jacks have several drawbacks. Manual jacks require significant effort and time to operate which leads to an increase in irrigator downtime. On the other hand, hydraulic jacks are only suited to use on hydraulic driven irrigators, which are rare. Given the length of the irrigator and number of towers the time and effort required to operate each jack is important in terms of minimising both irrigator downtime and the effort expended by the operator.

### SUMMARY OF THE INVENTION

According to the present invention there is provided a jack for raising a load, the jack being adapted to be fixed to the load;
the jack comprising a driving means coupled to a linkage which can be driven from an upper position to a lower position in order to raise the load,
the driving means comprising a rotating crank for driving the linkage whereby in one revolution the crank drives the linkage from the upper to the lower end and back to the upper position.

The jack may further comprise an electric motor which drives the rotating crank.

The linkage may be a parallelogram type linkage. In the lower position support arms of the linkage may be substantially vertical.

A connector rod may be pivotally connected to both the rotating crank and the linkage in order for the rotating crank to drive the linkage.

Preferably, the motor is a geared motor.

The invention further provides a pivot irrigator to which the jack described above, is fixed.

### BRIEF DESCRIPTION OF THE DRAWINGS

In order that the invention may be more easily understood, an embodiment will now be described, by way of example only, with reference to the accompanying drawings, in which:

FIG. 1 is an isometric view of a pivot irrigator tower including a fixed jack, shown in a stowed position;

FIG. 2 is an isometric view of the pivot irrigator tower including the fixed jack, the jack being in a lowered position;

FIG. 3 is plan view of the fixed jack;

FIG. 4 is a side elevational view of the jack;

FIG. 5 is an end elevational view of the jack; and

FIG. 6 is an isometric view of the jack.

### DESCRIPTION OF THE EMBODIMENTS

Although in this specification the invention is described in relation to its application to jacking up pivot irrigators it is believed to have applicability to other areas of activity including jacking up equipment, vehicles and other structures. There is no intention to limit the disclosure specifically to the pivot irrigator application.

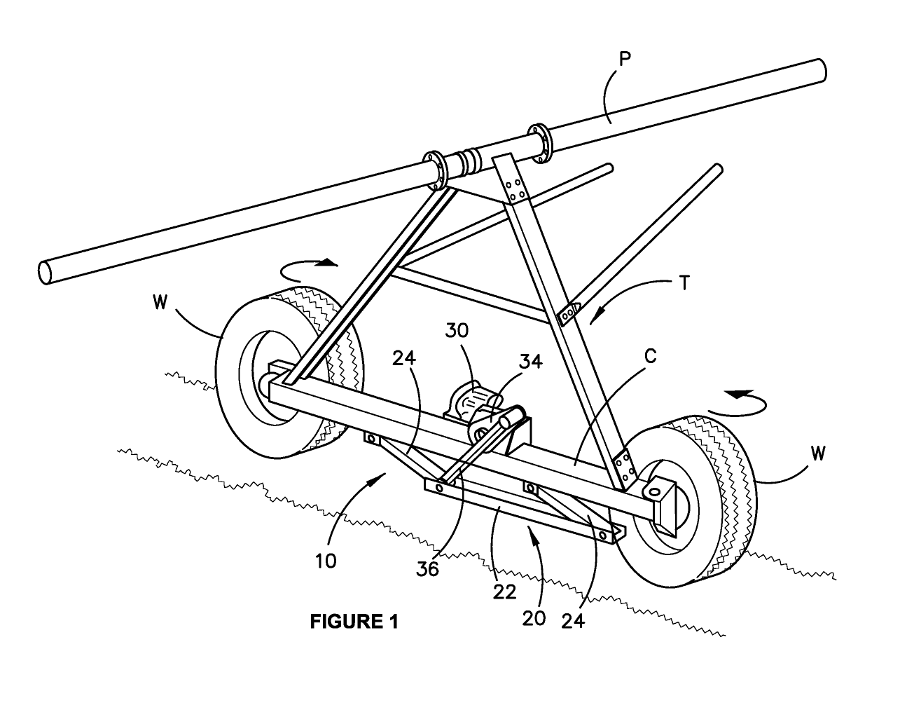

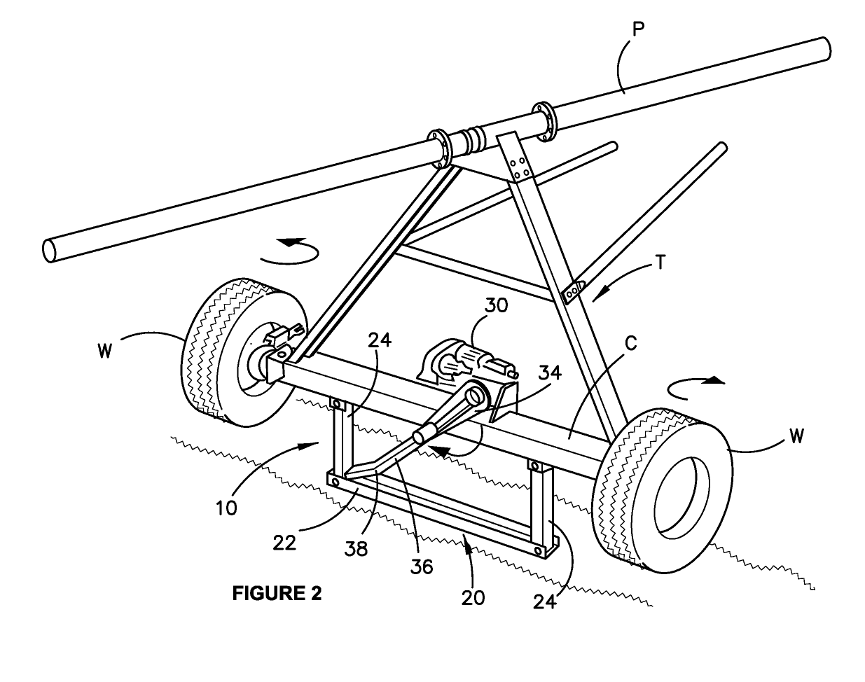

FIGS. 1 and 2 show a jack 10 fixed to the crossbar C of the support tower T of a centre pivot irrigator. The jack 10 may be welded or bolted to the crossbar C.

The tower T is adapted to support the pipeline P of the irrigator and rests on two wheels W. The wheels W are driven by geared motors (not shown) for the purpose of driving the irrigator. Each wheel W can be rotated around a vertical axis through a 90° angle from the operating position shown in FIG. 1 to the tow position shown in FIG. 2.

The jack 10 raises the tower T by lowering a parallelogram linkage 20 to a lower position. The linkage 20 is made up of a base plate 22 and two support arms 24. One end of each arm is mounted to the crossbar C such that the arms can pivot relative to the crossbar. The other end of each arm 24 is pivotally linked to each end of the base plate 22. The base plate 22 and arms 24 are in the same planes as the cross bar C.

During operation of the irrigator the arms 24 fold into an inclined configuration and the linkage is stowed in an upper position shown in FIG. 1. This position avoids entanglement of the jack 10 in the crop being irrigated. The arms 24 are lowered when the irrigator is stopped and the wheels W are to be rotated to their towing position (FIG. 2).

The linkage 20 is operated by a geared motor 30 which is mounted to the upper side of the crossbar C of the tower T. The output of the motor 30 is connected to a crank arm 34 which is pivotally connected to a connecting arm 36. The other end of the connecting arm 36 is in-turn pivotally connected at the intersection of one of the support arms 24 and the base plate 22.

The electric motor 30 is a 3 phase 415 volt AC electric motor which incorporates a reduction gear box 31 within the motor to terminate in an output shaft 33 that is connected to a worm gear 32 via a coupling 35. The output shaft 40 of the worm gear 32 drives the crank 34. The reduction from the electric motor 30 to the output shaft 40 driving the crank is between 3,000 to 1,000:1 preferably 1,000:1. The electric motor 30 has a forwardly projecting input shaft 41 that can, when necessary, be coupled to a ratchet drive (not shown) to allow manual overrun. Thus in the event of power or motor failure the input shaft 41 can be manually rotated to operate the jack 10.

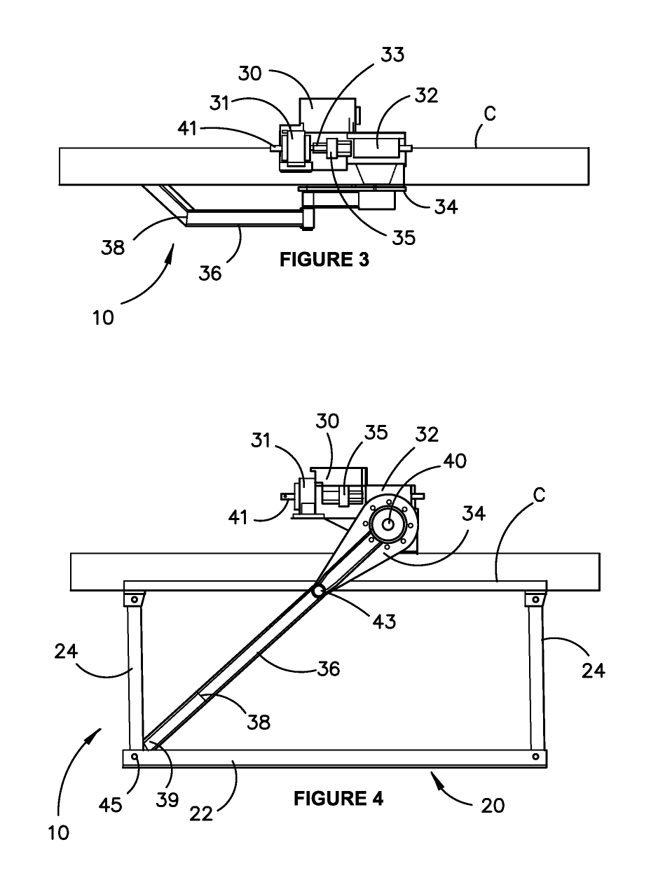

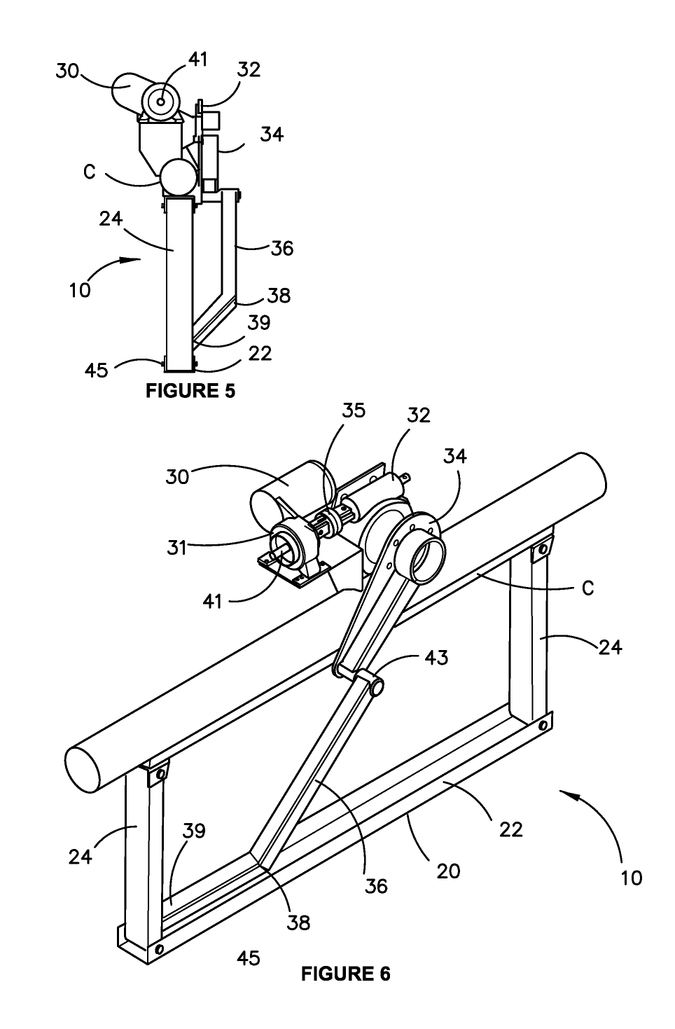

As shown in the detached views, the crank 34 (FIGS. 3 to 6) is quite a sturdy component that is mounted on the end of the output shaft 40. The crank 34 is in turn journalled at its end 43 to the connecting arm 36. To ensure that the crank 34 can complete a 360° rotation without impeding either the cross bar C or the connecting arm 36, the connecting arm 36 is off-set via a bend 38 as shown in FIG. 3 so the majority of the arm is in a plane displaced laterally from the plane of the jack 10 and cross bar C.

The lower end 39 of the connecting arm 36 is welded at an angle to a sleeve (not shown) that is secured by a bolt 45 between the upright 34 and base plate 22. The dimensions of the connecting arm 36 and especially the angled relationship of the components is carefully controlled by manufacture on jig to ensure precise location between the end of the crank 36 and base of the jack.

When the crank 34 is pointed upwards, as shown in FIG. 1, the linkage 20 is drawn upward into the stowed position. When the crank 34 is driven to the downward position shown in FIG. 2, the support arms 24 fold down to a vertical position and raise the tower T to the point where the wheels W leave the ground.

The jack 10 is designed to provide 200 mm of lift of the wheels W. The 200 mm lift is required to ensure wheel clearance especially when the base plate 22 has a tendency to dig into a soft ground surface.

The mechanical advantage offered by the ratio of length of the crank 34 and the proportions of the linkage 20 provides a high lifting force for a given motor torque.

As shown in FIGS. 3 to 6, the support arms 24 and base plate 22 are fabricated from steel bar with a C-shaped cross-section. The connecting arm 36 is a steel bar with a square cross-section. The various pivot points between the arms 24, base plate 22, crank 34 and connecting arm 36 operate using a simple pin and bush style bearings.

The motor 30 is operated by a push button (not shown) fixed to the motor housing. The button causes the motor to rotate in only one direction (eg. Counter-clockwise). It is an advantage of the present invention that the motor 30 need not be reversible. By rotating in only one direction the motor 30 can both raise and lower the linkage 20. Thus the crank 34 caused the jack 10 to move through two extreme positions namely fully extended (FIG. 2) and fully lifted (FIG. 1). The motor 30 can also be stopped until the jack 10 in any position between the two extremes.

In order to raise the wheels the push button is depressed until the linkage 20 is at its lowest point. On the other hand, the button is released when the linkage is at its upper most point in order to stow the jack during operation of the irrigator.

It is a further advantage of the invention that no limit switches or lock out devices are required as the motor can not drive the jack too far in either direction (up or down).

In other embodiments the motor may be a hydraulic motor or even a manually driven gearbox. However, in each case the motor or gearbox is fixed to the crossbar C and the user is not required to carry the motor or gearbox from one support tower to the next in order to operate the jack 10.

The electric motor 30 is a 3 phase AC motor because it is usual to irrigators of this kind to operate on a 3 phase system. It is, however, understood that the motor could operate as a single phase motor at lower voltages.

When fitted to an electric powered irrigator the jack may be powered from the same electrical distribution system that provides power to drive the wheels. This negates the requirement to provide a second power system to operate the jacks.

The control system may also be common to all or some of the jacks 10 along an irrigator. Thus by depressing a single button or activating a single control (ie. a wireless control) more than one jack 10 can be operated. It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A jack for raising a load, the jack being adapted to be fixed to the load;
the jack comprising driving means coupled to a linkage which can be driven from an upper position to a lower position in order to raise the load,
the driving means comprising a rotating crank for driving the linkage whereby on one revolution the crank drives the linkage from the upper to the lower and back to the upper position.

2. The jack according to claim 1, wherein the drive means comprises an electric motor.

3. The jack according to claim 2, wherein the electric motor drives the crank through a reduction gear box.

4. The jack according to claim 1, wherein the crank rotates only in one direction.

5. The jack according to claim 1, wherein the linkage is a parallelogram linkage comprising a base plate pivotally attached to support arms pivotally secured to the load whereby in the lower position the support arms of the linkage are substantially perpendicular to the base plate to raise the load.

6. The jack according to claim 5, wherein a connecting arm is pivotally connected to both the rotating crank and the base plate to enable the rotating crank to drive the linkage between the lower position in which the support arms are perpendicular and the upper position in which the support arms are inclined to the base plate.

7. The jack according to claim 6, wherein the supporting arm is in a plane off-set to the plane of the support arm and base plate.

8. The jack according to claim 3, wherein the electric motor drives a worm gear box which in turn drives the crank, the reduction being between 3,000:1 to 1,000:1.

9. The jack according to claim 3, wherein the electric motor has an input shaft that can be manually rotated to operate the jack in the event of power failure.

10. The jack according to claim 2, wherein the electric motor includes a push button which operates the jack when pressed.

11. A pivot irrigator comprising a wheeled chassis, a jack according to claim 1, secured to the underside of the chassis to, in use, when in the lower position, raise the wheels off the ground.
